(19) United States
(12) Patent Application Publication
(10) Pub. No.: US 2025/0051866 A1
(43) Pub. Date: Feb. 13, 2025

(54) A METHOD FOR PRODUCING IRON FUEL

(71) Applicant: RENEWABLE IRON FUEL TECHNOLOGY B.V., Nuenen (NL)

(72) Inventors: Lex SCHEEPERS, Nuenen (NL); Marcus Wilhelmus Petrus VERHAGEN, Nuenen (NL)

(21) Appl. No.: 18/722,983

(22) PCT Filed: Dec. 23, 2022
(86) PCT No.: PCT/NL2022/050757

§ 371 Date: Jun. 21, 2024

(30) Foreign Application Priority Data
Dec. 24, 2021 (NL) 2030295

(51) Int. Cl. C21B 13/00

(52) U.S. Cl. CPC C21B 13/0033; C21B 13/0073; C21B 2100/26; C21B 2100/28; C21B 2100/44

(57) ABSTRACT

The present invention relates to a method for producing iron fuel from metal oxide containing charge materials via reducing the metal oxide containing charge materials. An object of the present invention is to produce iron in a specific powder form having a particle size distribution and specific surface area, wherein the iron powder is to be used as a starting material for iron fuel combustion.

The present invention relates to a method for producing iron fuel from metal oxide containing charge materials via reducing the metal oxide containing charge materials.

Iron ore reduction with hydrogen mixtures as the reducing agent is industrially proven and is well known as such. Examples of industrial implementation relate to direct reduction processes. The input material in these processes is predominantly iron ore, which has a broad range of different properties in terms of particle size, morphology and composition. Moreover, these processes are designed for (usually liquid) steelmaking, which poses relatively unstrict requirements on particle morphology after reduction and which contains a carburization step to add carbon to the iron. In such steelmaking processes iron oxide and hydrogen are transported to the reactor, where the iron oxide is reduced to iron. The produced iron leaves the reactor and is subsequently transported and stored. Solids that are present in the outlet gas are separated in a gas-solid separation operation and returned to the reactor. The outlet gas is subjected to a gas separation operation for the removal of water vapor produced during the reaction. Unused hydrogen in the reactor outlet gas is recycled to the inlet of the reactor. These steelmaking processes are not based on the use of iron as a fuel source.

U.S. Pat. No. 4,082,545 relates to a process for the direct reduction of iron ore, comprising establishing a plurality of fluidized beds, heating and progressively reducing iron ore by passing the iron ore in series through the plurality of fluidized beds, fluidizing the beds with reducing gas by passing the reducing gas up through the bed, removing partially spent reducing gas from each the bed, cooling and washing the partially spent reducing gas to remove substantially all the solids there from, heating the washed gas, and again feeding the heated fluidizing gas through the bed.

US 2016/348199 relates to a method for reducing metal oxide containing charge materials, comprising: reducing the metal oxide containing charge materials by a reduction gas in at least a first and a second fluidized bed units, and flowing the reduction gas through the fluidized bed units counter currently to the metal oxide containing charge materials, removing as off-gas from the first fluidized bed unit the reduction gas used during reduction of the metal oxide containing charge materials in the at least two fluidized bed units, compressing at least some of the off-gas in at least one recycle gas compressor to produce hot recycle gas, and then cooling the hot recycle gas in at least one aftercooler to produce cold recycle gas, at least partially removing CO₂ from the cold recycle gas to produce product gas, admixing the product gas with the reduction gas, optionally after pre-heating in a heating device, conveying the metal oxide containing charge materials by a propellant gas from at least one delivery tank by a pipe line into the first fluidized bed unit.

U.S. Pat. No. 3,288,590 relates to a method of continuously reducing an iron oxide in particulate solids form with a reducing gas largely hydrogen under dilute phase suspension conditions which comprises grinding the iron oxide to all pass 100 mesh and have an average particle size of about 200 mesh, heating the reducing gas to a temperature in the range of 480 to under a pressure of 11-35 atm, passing the gas upwardly through a substantially vertical reaction zone, at a velocity in the range of 1.5 to 7.6 m/s, preheating the iron oxide to at least about 480 degr C, continuously feeding the finely divided preheated iron oxide to the rising column of reducing gas at a rate to maintain an average solids density in the range of 80-240 kg of metallic oxide per cubic meter of gas under the conditions in the rising column, and separately removing from the effluent of the reaction zone, a substantially solids-free gas and the reduced iron fines, wherein the reaction zone consist of a series of vertical chambers forming stages interconnected to accomplish a downflow of gases from the top of one stage interconnected to the upflow in the next stage.

U.S. Pat. No. 4,420,332 relates to a process for concurrently carrying out production of reduced iron and thermal cracking of a heavy oil which comprises the steps of introducing a fine iron ore and a heavy oil into a fluidized-bed thermal cracking reactor to effect thermal cracking of the heavy oil at a temperature in the range of 500 DEG to 600 DEG C. into products of thermal cracking and carbonaceous by-product material. The fine iron ore is in the form of particles having an average diameter of about 10-30 micrometre and the fine iron ore with deposits of the carbonaceous material is introduced into a first fluidized-bed reducing furnace and contacted with a reducing gas at high temperature blown thereinto in a fluidized state to reduce the fine iron ore into reduced iron at a temperature in the range from 800 DEG to 1000 DEG C. and to form an exhaust gas. The cracked gas, light oil and residual oil is separated by distillation from the products of thermal in a fractionation system, and a part of the reduced iron is transferred to a gas reformer wherein a fluidized-bed of the transferred reduced iron is formed in the gas reformer and the cracked gas or the residual oil is reformed by contact with the fluidized reduced iron in the gas reformer into a reducing gas mainly composed of hydrogen and carbon monoxide.

WO 00/01856 relates to a method for reducing iron-oxide-containing particles to metallic-iron-containing particles in a reducing zone of a moving bed reduction reactor with a reducing gas mainly composed of hydrogen and/or carbon monoxide, the method comprising introducing the iron-oxide-containing particles into the reducing zone at a first level to form a moving bed of particles in the lower portion of the reducing zone and extending down into a discharge zone of the reactor, injecting below the first level the reducing gas into the moving bed to define there above a moving bed reducing sub-zone, withdrawing from the reactor the overflow of the metallic-iron-containing particle fines from the top of the fluidized bed, withdrawing the reduced metallic-iron-containing particles from the nonfluidized moving bed in the discharge zone, and withdrawing the spent reducing/fluidizing gas from above the fluidized bed in the reduction zone.

U.S. Pat. No. 3,303,017 relates to a process of reducing iron: ore by direct reduction in a fluid bed, consisting of introducing the fluidizing gas into the fluid bed through multiple conical gas distributors, each of which is fed by a separate cyclone gas-solids separator, wherein the fluid bed comprises at least two conical gas distributors, each fed by a separate cyclone gas-solids separator, wherein the cyclones are located internally and directly feed gas to the conical gas distributors.

A disadvantage of the present processes for producing iron fuel from metal oxide containing charge materials via reducing the metal oxide containing charge materials is that these processes are unable to produce iron in a specific powder form to be used for the purpose of iron fuel combustion. One of the negative issues here is that particle agglomeration takes place in the process. Another negative one is that the produced material is pyrophoric. Both particle agglomeration and the formation of pyrophoric material form a barrier for the use of iron in a specific powder form as a starting material in iron fuel combustion.

The term “Pyrophoricity” is to be understood as a property of a material. In more detail, a material is qualified as pyrophoric if it ignites spontaneously in air at or below 54° C. or within 5 minutes after coming into contact with air. It is caused by the high specific surface area of the material, yielding an extremely low ignition temperature for oxidation. When the ignition temperature is low enough, auto-ignition at atmospheric conditions can take place. Pyrophoricity of iron particles after reduction has been reported to be a serious issue in fluidized bed reduction, where a high surface area of the material is obtained. The tendency to reoxidation depends on the reduction temperature. Studies have shown that the surface area of fine metal powders generally decreases with reduction temperature.

The term “agglomeration or sticking” is to be understood as a property of a material as well. Sticking of particles is regarded as the most serious problem encountered in reduction of iron oxide. It is especially problematic in fluidized bed reduction because it results in de-fluidization of the particle bed. And when particle bed de-fluidizes the reduction process of iron oxide cannot be continued. The factors affecting the sticking problem are for example temperature, metallization ratio, gas flow rate, the reducing atmosphere and particle properties. Generally, sticking is observed above a critical temperature and only occurs after the emerging of metallic iron. The latter is often ascribed to the formation of iron whiskers at higher metallization ratio which increases the sticking tendency of particles. An example of a method to prevent sticking includes the application of a low reduction temperature. Agglomeration will lead to loss of product quality since the product does not meet the desired requirements with regard to particle size.

An object of the present invention is to produce iron in a specific powder form having a particle size distribution and specific surface area, wherein the iron powder is to be used as a starting material for iron fuel combustion.

The present invention thus relates to a method for producing iron fuel from metal oxide containing charge materials via reducing the metal oxide containing charge materials according to the wording of claim 1.

The present inventors found that by applying specific process design features the agglomeration and pyrophoricity of particles can be limited. The iron powder thus produced is to be used as a starting material for iron fuel combustion.

The conditions in the fluidized bed are such that the bed is typically a bubbling fluidized bed. In a bubbling fluidized bed the gas rate is above the minimum fluidization rate. In a situation of minimum fluidization rate, at some location the force exerted upwards on every particle equals the particle weight, and the particle is suspended and the gas rate is called minimum fluidization rate. Any extra increase in rate creates bubbles of gas that quickly flow upward within the system, i.e. known as a bubbling fluidized bed. Increasing the superficial gas velocities will result in a transition from bubbling into the turbulent fluidized bed regime.

The combustion of iron yields various distinct types of iron oxide:hematite (Fe₂O₃) and magnetite (Fe₃O₄). These materials can be reduced by electricity and/or gaseous reducing agents including syngas, carbon monoxide, methane or hydrogen. The chemical processes taking place during the reduction of iron oxides by hydrogen are described by the equilibrium reactions:

Fe₂O₃(s)+3H₂(g) [symbol] 2Fe(s)+3H₂O(g)

Fe₃O₄(s)+4H₂(g) [symbol] 3Fe(s)+4H₂O(g)

FeO(s)+H₂(g) [symbol] Fe(s)+H₂O(g)

As the iron (oxide) does not reach a molten state in the process, it is also referred to as direct reduction. The chemical reactions show that the process involves reactions between solid and gaseous reactants. An important difference between reduction with hydrogen and with carbon monoxide, which is traditionally used for steel production in blast furnaces, is that reduction with hydrogen is endothermic. This means that energy must be added to the system to guarantee a constant reduction temperature. According to the present invention the addition of energy to the system can be done by preheating the input material or integrating a form of heating in the system design. According to the present invention a fluidized bed reactor is used for the purpose of contacting the gases and solids. The present system operates at a specific process conditions which will be discussed later here.

According to the present method the stream containing iron fuel is transported to a vessel. It is clear that such a vessel is to be understood as a construction wherein two or more vessels are present, for example a system consisting of vessels placed in parallel. The same situation applies for the fluidized bed unit. It is clear that several fluidized bed units may be placed in parallel or in series and the present method is by no means restricted to a specific number of fluidized bed units.

In an example, the step of removing partially spent reduction gas from the fluidized bed unit further comprises a step of separating coarse solids from the partially spent reduction gas and returning these coarse solids to the fluidized bed unit.

In an example, the method for producing iron fuel further comprises separating fine solids from the partially spent reduction gas after the step of separating the coarse solids.

In an example, the method for producing iron fuel further comprises a step of removing water from the partially spent reduction gas before returning the partially spent reduction gas to the fluidized bed unit.

In an example, the method for producing iron fuel further comprises a step of removing water from the mixture of partially spent reduction gas and fresh reduction gas before returning the mixture to the fluidized bed unit.

In an example, the aforementioned steps of removing water can be both applied in the method for producing iron fuel.

In an example, the water is removed from the partially spent reduction gas via one or more processes chosen from the group of condensation, adsorption, absorption and membrane filtering, or a combination thereof.

In an example, the method for producing iron fuel further comprises pre-heating and/or drying the metal oxide containing charge materials before feeding the materials into the fluidized bed unit, wherein the pre-heating temperature is preferably in a range of 40 and 1000° C.

In an example, the step of feeding the metal oxide containing charge materials to the fluidized bed unit further includes a step of pressurizing the metal oxide containing charge materials to the pressure prevailing in the fluidized bed unit.

In an example, the method for producing iron fuel further comprises a step of heat exchange between the partially spent reduction gas from the fluidized bed unit and the mixture of partially spent reduction gas and fresh reduction gas and, the heat exchange takes place before returning the mixture of partially spent reduction gas and fresh reduction gas to the fluidized bed unit.

In an example, the method for producing iron fuel further comprises pre-heating the mixture of partially spent reduction gas and fresh reduction gas before returning the mixture of partially spent reduction gas and fresh reduction gas to the fluidized bed unit.

The fluidized bed unit is preferably operated under the conditions of a pressure of at least 3 atm and at most 13 atm, more preferably at least 4 and at most 12 atm, a temperature of at least 400 and at most 800° C., more preferably at least 400 and at most 700° C., and a reduction gas velocity in the fluidized bed unit of at least 5 and at most 200 cm/s, more preferably at least 10 and at most 150 cm/s. The temperature of the reactor may be controlled by an external heating source.

In another example the method comprises the following steps:
feeding metal oxide containing charge materials to a fluidized bed unit,
reducing the metal oxide containing charge materials by flowing a reduction gas through the fluidized bed unit, wherein the fluidized bed unit is operated under the conditions of a pressure in a range of 1 and 15 atm, a temperature in a range of 300 and 1000° C. and a reduction gas velocity in the fluidized bed unit in a range of 0.9 cm/s and 270 cm/s,
removing partially spent reduction gas from the fluidized bed unit,
admixing the partially spent reduction gas with fresh reduction gas and returning the mixture of partially spent reduction gas and fresh reduction gas to the fluidized bed unit,
removing a stream containing iron fuel from the fluidized bed unit,
wherein the step of removing the stream containing iron fuel from the fluidized bed unit comprises the following sub-steps:
transporting the stream containing iron fuel to a vessel,
reducing the pressure of the vessel to ambient pressure,
cooling the stream containing iron fuel.

In an example the stream containing iron fuel while under pressure is cooled to a temperature below the point where agglomeration of the iron fuel occurs.

In an example the step of transporting the stream containing iron fuel and the step of cooling the stream containing iron fuel while under pressure takes place simultaneously.

The metal oxide containing charge materials consist of oxides of iron and unavoidable impurities, such as metals, for example nickel, manganese, copper, lead and cobalt, carbon and sulphates, or mixtures thereof.

In an example, the fluidized bed unit comprises a plurality of fluidized bed units placed in series.

In an example, the fresh reduction gas comprises hydrogen in an amount of at least 50 vol. %.

The iron fuel removed from the fluidized bed has a Sauter mean particle size of at least 10, preferably at least 20 μm, and at most 200 μm, preferably at most 150 μm.

The metal oxide containing charge materials have a Sauter mean particle size of at least 10, preferably at least 20 μm, and at most 300 μm, preferably at most 200 μm.

The drawings schematically illustrate an example of a method according to the invention according to the invention. The present method is not restricted to the specific example disclosed here.

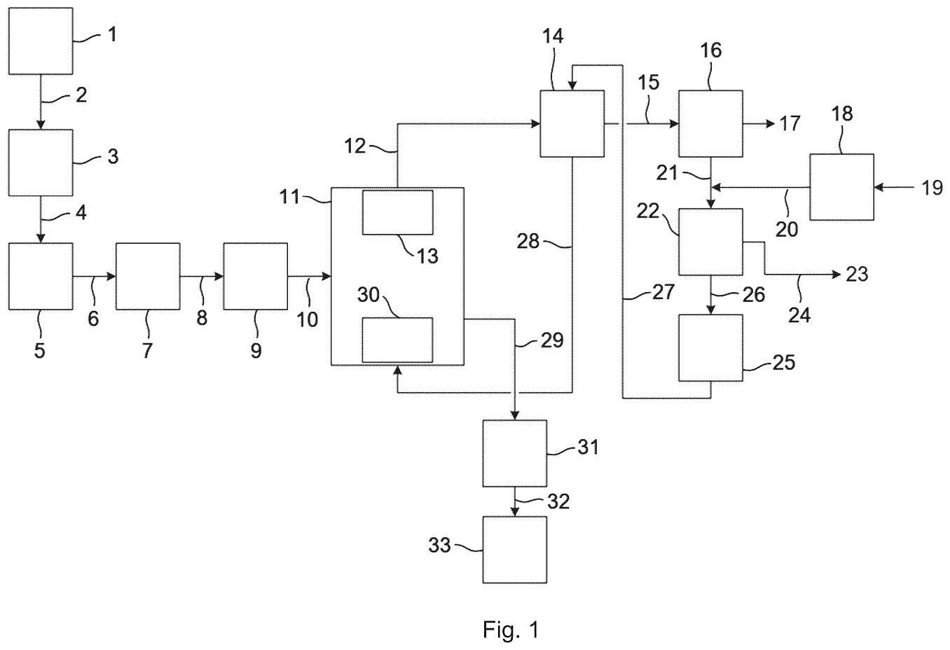

FIG. 1 is an example of the method for producing iron fuel.

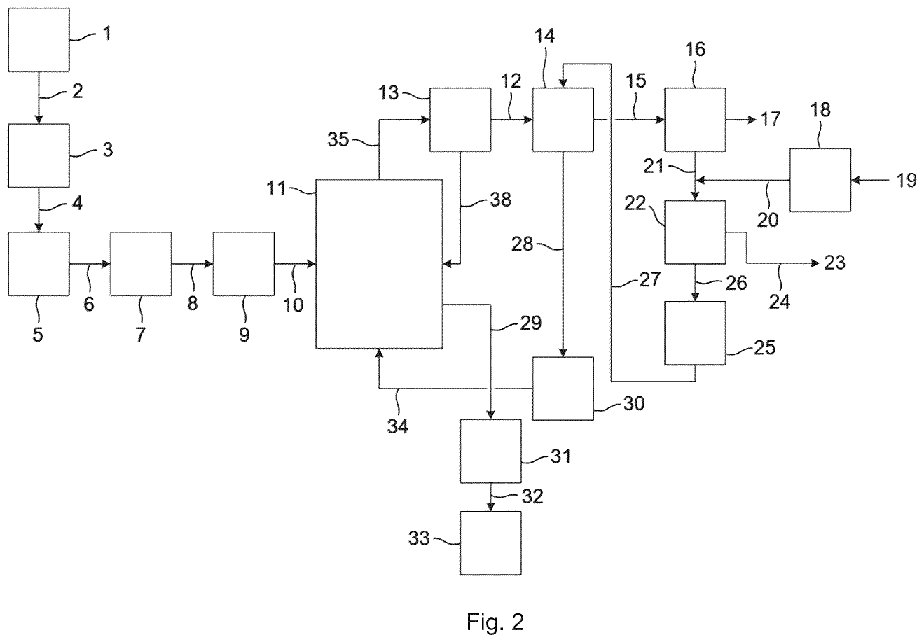

FIG. 2 is another example of the method for producing iron fuel.

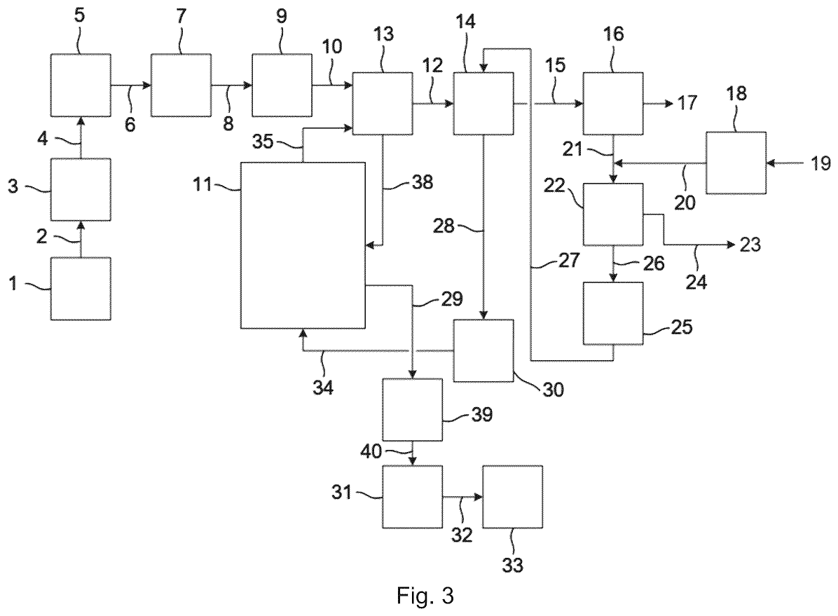

FIG. 3 is another example of the method for producing iron fuel.

The metal oxide containing charge materials 10, preferably oxides of iron, nickel, manganese, copper, lead or cobalt or mixtures thereof, are at least partially reduced or more specifically reduced by reduction gas 28 which flows through a fluidized bed unit 11 of metal oxide containing charge materials 10. Metal oxide containing charge materials 10 may undergo a pretreatment, consisting of a storage 1 and transport of metal oxide containing charge materials, i.e. iron oxide, preheating unit 3, lock hopper in 5, solids preheating 7 and solids feeding 9. The metal oxide containing charge materials originating from storage 1 are transported to an optional pre-heating unit 3. In case the charge materials are heated, a heated stream 4 is sent to lock hopper in 5. The function of lock hopper in 5 is to introduce the metal oxide particles in a pressurized environment to allow introduction of the solids into fluidized bed unit 11 at elevated pressure. An additional function of lock hopper in 5 is to prevent agglomeration of the starting materials via fluidization thereof. In addition, the function of lock hopper in 5 is to purge out any gaseous oxygen present in and in between metal oxide particles to ensure that substantially no oxygen enters fluidized bed unit 11. In an embodiment feed 6 originating from lock hopper in 5 is sent to an optional pre-heating unit 7. After such a treatment feed 8 is sent to a solids feeding unit 9. The function of unit 9 is to dose and feed the metal oxide particles 10 into fluidized bed unit 11. Pre-heating unit 7 may be incorporated in unit 9. In fluidized bed unit 11 the metal oxide particles are contacted with the reducing agent, i.e. a hydrogen-containing gas thereby converting metal oxide particles into metal particles. Fluidized bed unit 11 may also include a heating unit 30 for controlling the reaction temperature. Coarse particles from the gas stream exiting the particle bed present in fluidized bed unit 11 are separated from the gas flow and the coarse particles thus separated are returned into the particle bed present in fluidized bed unit 11. Gas flow 12 exiting fluidized bed unit 11 is sent to heat exchanger 14. In heat exchanger 14 the energy of gas flow 12 is exchanged with hydrogen gas flow 27. The function heat exchanger 14 is thus cooling gas flow 12 that is discharged from the coarse particle separation while pre-heating hydrogen gas flow 27 that will eventually enter fluidized bed unit 11 thereby increasing the energy efficiency of the total system. Gas flow 15 coming from heat exchanger 15 is sent to separator unit 16. The function of separator unit 16 is to separate and to discharge fine particles from gas flow 15 exiting heat exchanger 14. Fine particles 17 are discharged and stored. A make-up hydrogen gas flow 20 is combined with gas flow 21. Hydrogen gas flow 19 may be compressed in compressor 18 resulting in hydrogen gas flow 20. The combined hydrogen gas flow, i.e. hydrogen gas flow 20 and hydrogen gas flow 21, may contain water and other impurities, and water and other impurities are removed in water removal unit 22 and the resulting flow 24 is discharged. The function of water removal unit 22 is not only cooling gas flow 21 to effectuate condensation of water vapor from gas flow 21 but to separate and discharge the condensed water from the gas stream which is recycled. Gas flow 26 originating from water removal unit 22 is sent to compressor 25 and gas flow 27 thus compressed is routed to heat exchanger 14. The function of compressor 25 is to pressurize recycle gas to overcome any pressure drop across the system and to create gas velocity in fluidized bed unit 11. The heated gas flow 28 is sent to fluidized bed unit 11. Product stream 29 coming from fluidized bed unit 11 is sent to lock hopper unit 31. Lock hopper unit 31 has out has multiple functionalities, i.e. to cool down particles containing product stream 29 with an inert gas in order to prevent sticking/agglomeration of the particles and to prevent oxidation of the particles when exposed to ambient air. Agglomeration will lead to loss of product quality, since the product does not meet the desired requirements with regard to particle size. Contact with ambient air will lead to a loss of product quality as well. In addition, lock hopper unit 31 may also be provided with an inert gas flow for fluidizing the iron particles to prevent sticking in the lock hopper system itself while cooling. Furthermore, in lock hopper unit 31 the pressure of the iron particles stream 29 is brought from system pressure back to atmospheric pressure. Product stream 29 may also contain hydrogen gas and remaining parts of hydrogen and water are flushed. The removal of hydrogen from product stream 29 ensures that no reaction takes place outside fluidized bed unit 11 and allows for safe operation of downstream operations. The iron particles containing stream 32 is stored in iron fuel storage 33. It is to be noted that dry particles 32 ensure a safe storage, without the risk of iron particles being oxidized by water or clogging as a result of water condensation in storage containers 33.

The process scheme according to FIG. 2 is similar to the one shown in FIG. 1, except for the situation around fluidized bed unit 11. Metal oxide particles 10 are fed into fluidized bed unit 11 and mixed stream 35 of coarse particles and hydrogen is sent to separator 13. In separator 12 a stream 38 of coarse particles is recycled into fluidized bed unit 11. Gas flow 12 comprising hydrogen and fine particles coming from fluidized bed unit 11 is sent to heat exchanger 14. In heat exchanger 14 the energy of gas flow 12 is exchanged with hydrogen gas flow 27. The function heat exchanger 14 is thus cooling gas flow 12 that is discharged from the coarse particle separation while pre-heating hydrogen gas flow 27 that will eventually enter fluidized bed unit 11 thereby increasing the energy efficiency of the total system. The heated gas flow 28 is sent to fluidized bed unit 11 and may be further heated by heater 30, resulting in hydrogen gas flow 34. All remainder process units and streams are similar to the ones discussed above in connection with FIG. 1.

The process scheme according to FIG. 3 is similar to the one shown in FIG. 2, except for the situation at the outlet of fluidized bed unit 11. Product stream 29 coming from fluidized bed unit 11 is sent to unit 39 for cooling down the particles containing product stream 29, preferably with an inert gas in order to prevent sticking/agglomeration of the particles and to prevent oxidation of the particles when exposed to ambient air. Agglomeration will lead to loss of product quality since the product does not meet the desired requirements with regard to particle size. Contact with ambient air will lead to a loss of product quality as well. The stream 40 thus cooled is sent to lock hopper unit 31 and unit 31 may also be provided with an inert gas flow for fluidizing the iron particles to prevent sticking in the lock hopper system itself while cooling. Furthermore, in lock hopper unit 31 the pressure of the iron particles stream 40 is brought from system pressure back to atmospheric pressure. The iron particles containing stream 32 is stored in iron fuel storage 33. It is to be noted that dry particles 32 ensure a safe storage, without the risk of iron particles being oxidized by water or clogging as a result of water condensation in storage containers 33.

1. A method for producing iron fuel from metal oxide containing charge materials via reducing the metal oxide containing charge materials, the method comprising the following steps:
feeding metal oxide containing charge materials to a fluidized bed unit, the metal oxide containing charge materials having a Sauter mean particle size of at least 10, and at most 300 μm,
reducing the metal oxide containing charge materials by flowing a reduction gas through the fluidized bed unit, wherein the fluidized bed unit is operated under the conditions of a pressure in a range of 3 and 13 atm a temperature in a range of 400 and 800° C., and a reduction gas velocity in the fluidized bed unit in a range of 5 and 200 cm/s,
removing partially spent reduction gas from the fluidized bed unit,
admixing the partially spent reduction gas with fresh reduction gas and returning the mixture of partially spent reduction gas and fresh reduction gas to the fluidized bed unit,
removing a stream containing iron fuel from the fluidized bed unit, the iron fuel removed from the fluidized bed having a Sauter mean particle size of at least 10, and at most 200 μm,
wherein the step of removing the stream containing iron fuel from the fluidized bed unit comprises the following sub-steps:
transporting the stream containing iron fuel to a vessel and cooling the stream containing iron fuel while under pressure, wherein an inert gas flow during cooling is applied for removing moisture from the iron fuel,
reducing the pressure of the vessel to ambient pressure, and
storing the iron fuel thus obtained.

2. A method according to claim 1, wherein the step of removing partially spent reduction gas from the fluidized bed unit further comprises a step of separating coarse solids from the partially spent reduction gas and returning these coarse solids to the fluidized bed unit.

3. A method according to claim 2, further comprising separating fine solids from the partially spent reduction gas and/or from the mixture of partially spent reduction gas and fresh reduction gas, after the step of separating the coarse solids.

4. A method according to claim 1, further comprising a step of removing water from a stream selected from the group of partially spent reduction gas and the mixture of partially spent reduction gas and fresh reduction gas, or a combination thereof, before returning the stream to the fluidized bed unit.

5. A method according to claim 4, wherein the water is removed from the partially spent reduction gas via one or more processes chosen from the group of condensation, adsorption, absorption and membrane filtering, or a combination thereof.

6. A method according to claim 1, further comprising pre-heating and/or drying the metal oxide containing charge materials before feeding the materials into the fluidized bed unit.

7. A method according to claim 6, wherein the pre-heating temperature is in a range of 40 and 1000° C.

8. A method according to claim 1, wherein the step of feeding the metal oxide containing charge materials to the fluidized bed unit includes a step of pressurizing the metal oxide containing charge materials to the pressure prevailing in the fluidized bed unit.

9. A method according to claim 1, further comprising a step of heat exchange between the partially spent reduction gas from the fluidized bed unit and the mixture of partially spent reduction gas and fresh reduction gas and, the heat exchange takes place before returning the mixture of partially spent reduction gas and fresh reduction gas to the fluidized bed unit.

10. A method according to claim 1, further comprising pre-heating the mixture of partially spent reduction gas and fresh reduction gas before returning the mixture of partially spent reduction gas and fresh reduction gas to the fluidized bed unit.

11. A method according to claim 1, wherein the metal oxide containing charge materials include consist of oxides of iron and unavoidable impurities, such as metals, for example nickel, manganese, copper, lead and cobalt, carbon and sulphates, or mixtures thereof.

12. A method according to claim 1, wherein the fluidized bed unit comprises a plurality of fluidized bed units placed in series.

13. A method according to claim 1, wherein the fresh reduction gas comprises hydrogen in an amount of at least 50 vol. %.

14. A method according to claim 1, wherein the stream containing iron fuel while under pressure is cooled to a temperature below the point where agglomeration of the iron fuel occurs.

15. A method according to claim 1, wherein the step of transporting the stream containing iron fuel and the step of cooling the stream containing iron fuel while under pressure takes place simultaneously.
